(19) United States
(12) Patent Application Publication
(10) Pub. No.: US 2015/0127334 A1
(43) Pub. Date: May 7, 2015

(54) Speech Recognition Based Asset Management System For Tagging Legacy LPG Containers

(71) Applicant: Joseph V. Masin, Santa Barbara, CA (US)

(72) Inventor: Joseph V. Masin, Santa Barbara, CA (US)

(21) Appl. No.: 14/071,948

(22) Filed: Nov. 5, 2013

(51) Int. Cl. G10L 21/00

(52) U.S. Cl. CPC G10L 21/00
USPC 704/231; 235/375

(57) ABSTRACT

Speech recognition based asset management systems and related methods are disclosed for tagging legacy LPG (liquefied petroleum gas) containers, such as LPG cylinders, and tracking associated data for the LPG containers. Embodiments described herein utilize a speech recognition processor to capture data associated with legacy LPG containers that are being tagged with electronic identification tags. The operator reads aloud the container information for the legacy LPG containers being tagged to produce voice signals for the container information, and the asset management system uses speech recognition to convert these voice signals to digital data that can be reviewed, modified, and verified by the operator before it is stored along with a tag identifier within a database system for later retrieval, as needed.

### TECHNICAL FIELD OF THE INVENTION

The present invention relates generally to asset tracking for LPG (liquefied petroleum gas) containers and, more particularly, to tagging legacy LPG containers.

### BACKGROUND

Prior electronic identification tags, including LF-RFID (low frequency radio frequency identification) tags and UHF-RFID (ultra-high frequency radio frequency identification) tags, have been used for assets management, container safety inspection purposes, fraud prevention, ownership identification, and/or other purposes. For asset tracking, electronic identification tags typically include on-board or associated external data storage systems that can be loaded with identification information associated with items to be tracked, can be adhered or otherwise affixed to the item, and can later be read by an electronic reader to obtain the stored identification information. Electronic identification tags are typically implemented as an assembly incorporating a transponder assembly within a protective housing.

One application for electronic identification tags is to track hazardous products, such as LPG (liquefied petroleum gas) containers, such as LPG cylinders. When an LPG operator desires to start using RFID tags for asset management and cylinder tracking, there are often large numbers of legacy LPG cylinders that need to be tagged. As part of this tagging process, cylinder data for these legacy LPG cylinders must be entered reliably into the tracking database system for the LPG operator, while minimizing data entry errors. Typically, each LPG cylinder has cylinder data, such as a cylinder serial number, tare weight (i.e., weight of container when empty), manufacturer name, requalification date, and/or other important data, embossed on its cylinder body and/or on a protective collar/handle. However, the legacy LPG cylinders are often in poor condition, and the embossed cylinder data is difficult to read from the cylinder. Prior efforts to capture this cylinder data into asset tracking database systems have included manual data entry and electronic OCR (optical character recognition) techniques.

FIG. 1 (Prior Art) is a diagram of an embodiment 100 for manual data entry of cylinder data for a legacy LPG container 102. The legacy LPG container 102 can be, for example, a metal cylinder configured to hold LPG (liquefied petroleum gas). The cylinder 102 can be configured to include a metal valve flange 108 welded into a central opening at the top of the cylinder 102. The metal valve flange 108 can be configured to receive a valve system that allows LPG to be loaded into and removed from the cylinder 102. In addition, one or more metal stay plates 106 can also be connected to the gas containing portion of the cylinder 102 and to a metal ring 110. The metal ring 110 can be used, for example, to protect the valve system coupled to the metal valve flange 108. The metal ring 110 can also be used for picking up and/or moving the cylinder 102 and can add further protection for the valve system. It is further noted that the cylinder 102 can be alternatively provided with a protective handle or collar without using stay plates 106. For example, a curved piece of metal with an integrated handle can be welded to the cylinder body to provide a protective handle/collar for the cylinder 102. Other configurations could also be utilized, as desired.

As further depicted, the legacy cylinder 102 includes cylinder data 104 that is embossed or otherwise affixed to the cylinder 102, the handle assembly, or to some other feature or aspect of the overall cylinder assembly. The legacy cylinder 102 does not have an electronic identification tag previously associated with it. The log system 120 is used to add the cylinder data to a database system that stores the cylinder data for the cylinders being tracked by an LPG operator with an electronic identification tag. For embodiment 100, cylinder data 104 is converted into electronic cylinder data 124 using manual data entry through key pad 122. This manual data entry solution, however, is relatively slow and is subject to large numbers of data entry errors. As such, the manual data entry solution is not sufficiently fast or reliable for it to be a viable solution for capturing legacy LPG cylinder data for large operations.

Another prior solution for large operations that are tagging legacy LPG cylinders is to pass each legacy cylinder 102 close to an optical reader 214 that can capture the cylinder data 104, as shown for embodiment 200 in FIG. 2 (Prior Art). In particular, embodiment 200 provides an OCR (optical character recognition) solution for capturing legacy cylinder data. As depicted, OCR reader 214 is brought in close proximity to the cylinder data 104, optically reads the cylinder data 104, and converts it into OCR data results 212 that represent an electronic alphanumeric version of the cylinder data 104. These OCR data results 212 are then stored within a database system for the log system 210. This OCR solution, however, is prone to reading errors and conversion errors due to the typically poor condition of cylinder data 104 embossed on the legacy cylinders 102. These poor conditions lead to difficulties in optically reading the cylinder data 104 and thereby to high numbers of recognition errors in the OCR data results 212. Thus, as with the manual data entry solution of FIG. 1 (Prior Art), the prior OCR solution is not sufficiently fast or reliable for it to be a viable solution for capturing legacy LPG cylinder data for large operations.

### SUMMARY OF THE INVENTION

Speech recognition based asset management systems and related methods are disclosed for tagging legacy LPG (liquefied petroleum gas) containers, such as LPG cylinders, and tracking associated data for the LPG containers. Embodiments described herein utilize a speech recognition processor to capture data associated with legacy LPG containers that are being tagged with electronic identification tags. The operator reads aloud the container information for the legacy LPG containers being tagged to produce voice signals for the container information, and the asset management system uses speech recognition to convert these voice signals to digital data that can be reviewed, modified, and verified by the operator before it is stored along with a tag identifier within a database system for later retrieval, as needed. Other features and variations can be implemented, if desired, and related systems and methods can be utilized as well.

For one embodiment, a method is disclosed for identifying previously used liquefied petroleum gas (LPG) containers including the steps of providing a radio frequency identification (RFID) tag for a liquefied petroleum gas (LPG) container where the LPG container has been previously used to store liquefied petroleum gas, receiving voice signals representing information associated with the LPG container, using a speech recognition processor to convert the voice signals to digital data representing the information, associating the digital data for the LPG container with a tag identifier for the RFID tag, storing the digital data and the tag identifier within a database system, and repeating the providing, receiving, using, associating, and storing steps a plurality of times. For certain additional embodiments, the LPG container can be an LPG cylinder, although other container configurations can also be used.

In further embodiments, the method further includes reading the RFID tag with an RFID tag reader to read obtain the tag identifier. In addition, the reading step can be conducted before the receiving step or can be conducted after the receiving step. Further, the method can include providing the digital data to a user through a user interface and allowing the user to modify the digital data through a data modification interface. Still further, the method can include receiving modifications to the digital data to form modified digital data and storing the modified digital data with the tag identifier in the database system. Also, the data modification interface can be at least one of a keyboard or a touch screen interface. For some embodiments, the providing, receiving, using, associating, storing, and repeating steps can be performed using a single processing system. For other embodiments, the providing, receiving, using, associating, storing, and repeating steps can be performed using a plurality of processing systems.

For another embodiment, a system is disclosed for identifying previously used liquefied petroleum gas (LPG) containers including a microphone configured to receive voice signals representing information associated with a previously-used liquefied petroleum gas (LPG) container, a speech recognition processor configured to convert the voice signals to digital data representing the information, a database system, and a processor configured to associate the digital data from the speech recognition processor with a tag identifier for a radio frequency identification (RFID) tag for the LPG container and to cause the digital data and the tag identifier to be stored in the database system. The system is further configured to store digital data and tag identifiers for a plurality of previously-used LPG containers. For certain additional embodiments, the LPG container can be an LPG cylinder, although other container configurations can also be used.

In further embodiments, the system can include an RFID tag reader configured to read the RFID tag to obtain the tag identifier. In addition, the system can include a user interface, and the processor can be further configured to provide the digital data to a user through the user interface. Further, the system can include a data modification interface, and the processor can be further configured to receive user modifications to the digital data through the data modification interface and to store modified digital data with the tag identifier in the database system. Still further, the user interface can be at least one of a visual display system or a voice prompt system. Also, the user interface and the data modification interface can be provided through a common touch screen interface. In addition, the data modification interface can be a keyboard. For some embodiments, the microphone, speech recognition processor, database system, and processor are implemented within a single processing system. For other embodiments, the microphone, speech recognition processor, database system, and processor are implemented within a plurality of processing systems.

Different features and further variations can also be implemented, if desired, and related systems and methods can be utilized as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 (Prior Art) is a diagram of an embodiment for manual data entry of cylinder data for a legacy LPG (liquefied petroleum gas) cylinder.

FIG. 2 (Prior Art) is a diagram of an embodiment for using optical character recognition (OCR) to acquire cylinder data for legacy LPG cylinders.

FIG. 3 is a diagram of an embodiment for a speech recognition based asset management system for tagging legacy LPG containers, such as LPG cylinders.

FIG. 4 is a process flow diagram of embodiment for using speech recognition to acquire container information and to generate digital data used to tag legacy LPG containers, such as LPG cylinders, for an asset management system.

FIG. 5 is a more detailed diagram of an embodiment for an asset management system that uses speech recognition to tag legacy LPG containers, such as LPG cylinders.

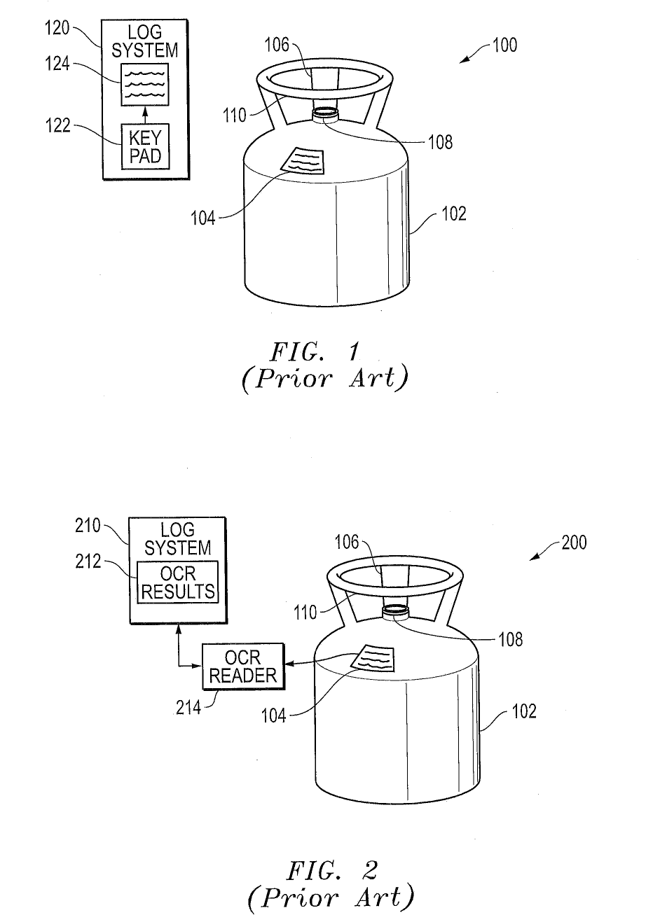

### DETAILED DESCRIPTION OF THE INVENTION

Speech recognition based asset management systems and related methods are disclosed for tagging legacy LPG (liquefied petroleum gas) containers, such as LPG cylinders, and tracking associated data for the LPG containers. Embodiments described herein utilize a speech recognition processor to capture data associated with legacy LPG containers that are being tagged with electronic identification tags. The operator reads aloud the container information for the legacy LPG containers being tagged to produce voice signals for the container information, and the asset management system uses speech recognition to convert these voice signals to digital data that can be reviewed, modified, and verified by the operator before it is stored along with a tag identifier within a database system for later retrieval, as needed. Other features and variations can be implemented, if desired, and related systems and methods can be utilized as well.

As described herein, the disclosed embodiments allow for rapid and accurate capture of legacy LPG container information using speech recognition. Once a legacy LPG container, such as an LPG cylinder, is associated with an electronic identification tag, the operator audibly reads the cylinder data affixed to the cylinder. Speech recognition is then used to capture the voice signals and convert the audible speech into digital data. The digital data is then displayed or otherwise provided to the operator so that the operator can review the data just dictated and captured. The operator can then modify this data using voice prompts and/or key data entry, as needed, to generate verified cylinder data associated with the legacy LPG cylinder. The cylinder's electronic identification tag can be scanned before, during or after the data capture process so that the captured and verified cylinder data can be matched with the tag identifier for the new electronic identification tag. The cylinder data and the tag identifier are associated with each other and stored within the database system. It is noted that the electronic identification tags can be low frequency RFID (radio frequency identification) tags, UHF (ultra-high frequency) RFID tags, an RFID system that uses magnetic coupling created between the transponder and the metal mass of the LPG cylinder, and/or any other desired electronic identification tags.

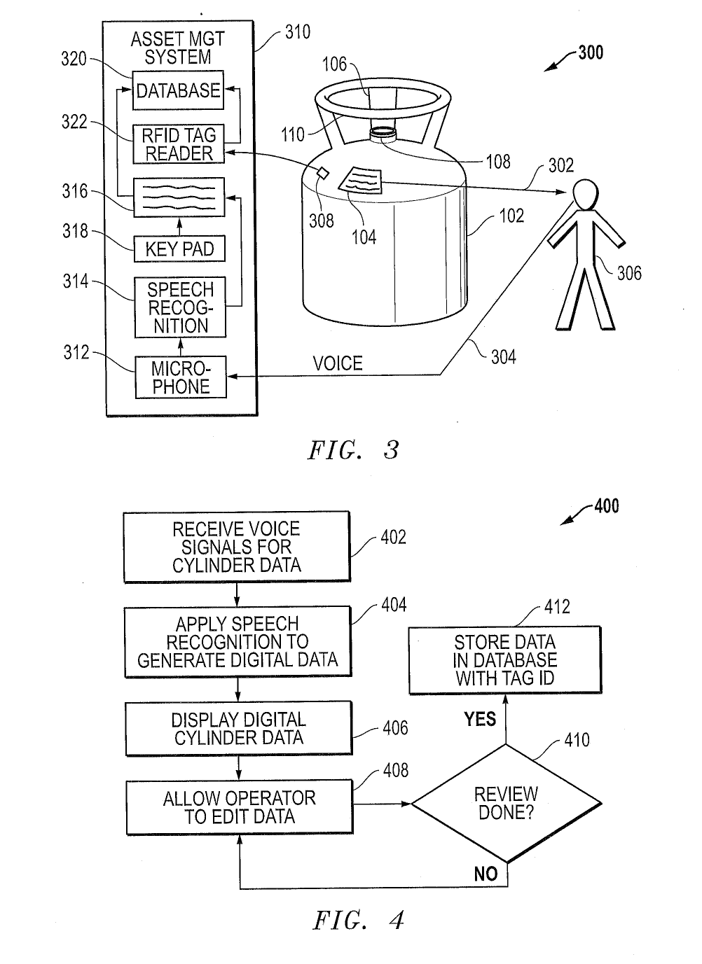

FIG. 3 is a diagram of an embodiment 300 for a speech recognition based asset management system 310 for tagging legacy LPG containers, such as LPG cylinders. As above, the legacy LPG cylinder 102 is configured to hold LPG and includes a valve flange 108, stay plates 106, and metal ring 110, although other container configurations could also be utilized. Also as above, the legacy LPG cylinder 102 includes cylinder data 104 that is embossed or otherwise affixed to the legacy LPG cylinder 102. To capture this cylinder data 104 for the asset management system, the operator 306 reads the cylinder data 104 as represented by arrow 302 and produces voice signals representing the cylinder data 104 as represented by arrow 304. The asset management system 310 includes a microphone 312 that receives the voice signals and provides them to speech recognition processor 314. Speech recognition processor 314 converts the voice signals into digital alphanumeric representations to produce digital data 316. This digital data 316 can be provided back to the operator 306 (e.g., visual display system or voice prompt system), and key pad 318 or another data modification interface can be used by the operator to modify the displayed information to correct it as needed. As such, the accuracy of the captured digital data 316 can be verified and corrected by the operator 306. The digital data 316 for the legacy LPG cylinder 102 can then be stored within a database system 320 for the log system 310 along with a tag identifier (ID) obtained by RFID tag reader 322 from an RFID tag 308 that is associated with the legacy LPG cylinder 102.

It is noted that the asset management system 310 can be implemented as one or more separate devices and/or processing systems. The speech recognition processor 314 can be any desired speech recognition engine that is configured to convert voice signals to digital data representations of spoken words, numbers, and/or symbols within the voice signals. Further, it is noted that the cylinder 102 can be any desired container that is configured to hold gas and/or other desired material. In addition, the key pad 318 can be any desired alphanumeric data entry device, such as a full-size keyboard, reduced-size keyboard, touch screen keyboard, and/or another manual data entry interface. Further, modifications to the captured digital cylinder data can also be made through voice commands or other techniques, as desired. Other variations and different features could also be implemented.

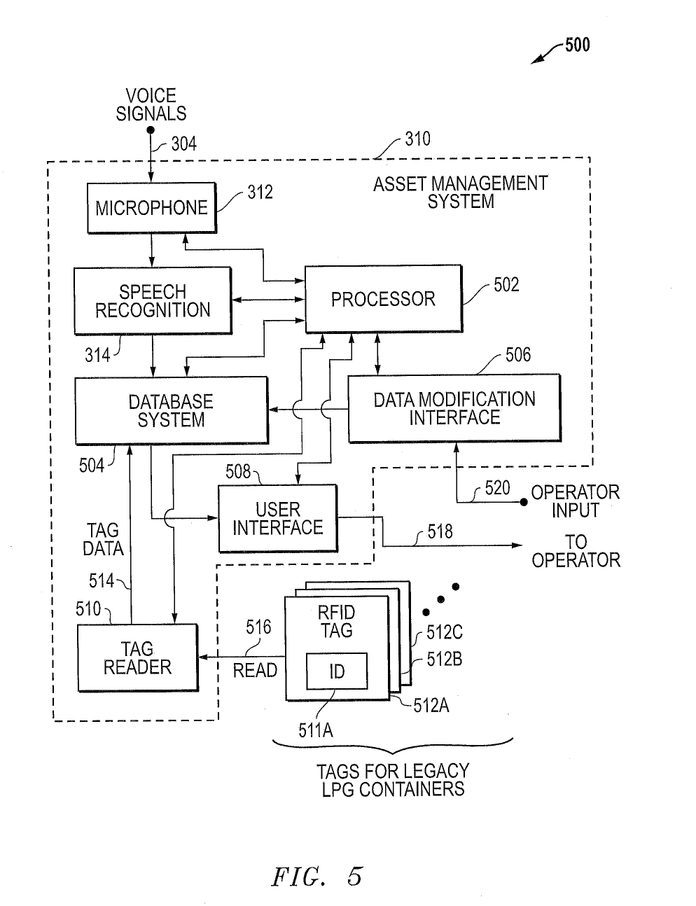

FIG. 4 is a process flow diagram of embodiment 400 for using speech recognition to tag legacy LPG containers, such as LPG cylinders, for an asset management system. In block 402, voice signals relating to cylinder data for a legacy LPG cylinder is received from an operator audibly reading the cylinder data. In block 404, a speech recognition processing is applied to the voice signals to generate cylinder data associated with the voice signals. In block 406, the digital cylinder data is displayed to the operator through a user interface. In block 408, the operator is allowed to edit the digital cylinder data through a user interface. In block 410, a determination is made whether the operator is done with review of the digital cylinder data. If “NO,” then flow passes back to block 408. If “YES” and the operator has indicated that the digital data is verified, flow passes to block 412 where the data is stored in a database system along with the identifier (ID) for the electronic identified tag associated with the legacy LPG cylinder.

FIG. 5 is a more detailed diagram of an embodiment 500 for an asset management system 310. For the embodiment depicted, a number of RFID tags 512A, 512B, 512C . . . are to be used to tag legacy LPG containers, such as LPG cylinders. As shown with respect to identifier (ID) 511A for RFID tag 512A, each of the RFID tags 512A, 512B, 512C . . . has a unique identifier (ID) stored within it. For each legacy LPG cylinder, the RFID tag reader 510 reads the RFID tag that will be associated with that legacy LPG cylinder and provides tag data 514 representing the RFID tag identifier information read from an RFID tag, such as identifier (ID) 511A for RFID tag 512A, to the database system 504. For each legacy LPG cylinder, the operator also audibly reads the cylinder data, as described herein, and generates voice signals 304 associated with the cylinder data. These voice signals 304 are received by microphone 312 and are provided to speech recognition processor 314. The speech recognition processor 314 converts the voice signals 304 to digital alphanumeric representations in order to generate digital cylinder data for the legacy LPG cylinder. The digital cylinder data is provided to the database system 504 to be stored along with the tag identifier data 514 for that legacy LPG cylinder. The user interface 508 is used to display (e.g., visual display system) or otherwise provide (e.g., voice prompt system) the captured digital data to the operator as indicated by arrow 518. The operator may then modify the captured digital data, as needed, through data modification interface 506 by providing operator input 520 (e.g., typed changes, touch inputs, voice commands, and/or other inputs). It is also noted that the user interface 508 and the data modification interface 506 can be provided by the same interface, such as for example, a touch screen interface. The resulting verified and/or modified data can then be stored along with the tag data 514 for that legacy LPG cylinder for future access when the tag ID 154 is subsequently read for asset management purposes.

It is noted that a processor 502 can be configured to communicate with the microphone 312, the speech recognition processor 314, the database system 504, the user interface 508, the data modification interface 506, and the RFID tag reader 510 in order to provide operational control of the asset management system 310. The processor 502 can be a central processing unit, microcontroller, and/or any other desired processing system of device. It is also noted that a single processing system could be used to implement the embodiments described herein, or a plurality of processing systems could be used to implement the embodiments described herein. Where a plurality of processing systems are used, the functional blocks and operations described herein can be apportioned among the processing systems, as desired. It is further noted that the data modification interface can be a wide variety of user interfaces, including touch screens, stand-alone keyboards, voice command interfaces, and/or other desired user interfaces. It is further noted that the user interface 508 can be a wide variety of user interfaces including a visual display interface, voice prompt interface, and/or any other desired interface for providing the captured digital data to the operator.

It is noted that the functional blocks described herein for the asset management system, including the speech recognition processor, can be implemented using hardware, software, or a combination of hardware and software, as desired. In addition, one or more processors or processing circuitry running software and/or firmware can also be used, as desired, to implement the disclosed embodiments. It is further understood that one or more of the operations, tasks, functions, or methodologies described herein may be implemented, for example, as software or firmware and/or other program instructions that are embodied in one or more non-transitory tangible computer readable mediums (e.g., memory) and that are executed by one or more controllers, microcontrollers, microprocessors, hardware accelerators, and/or other processors or processing circuitry to perform the operations and functions described herein.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for identifying previously used liquefied petroleum gas (LPG) containers, comprising:
providing a radio frequency identification (RFID) tag for a liquefied petroleum gas (LPG) container, the LPG container having been previously used to store liquefied petroleum gas;
receiving voice signals representing information associated with the LPG container;
using a speech recognition processor to convert the voice signals to digital data representing the information;
associating the digital data for the LPG container with a tag identifier for the RFID tag;
storing the digital data and the tag identifier within a database system; and
repeating the providing, receiving, using, associating, and storing steps a plurality of times.

2. The method of claim 1, further comprising reading the RFID tag with an RFID tag reader to obtain the tag identifier.

3. The method of claim 2, wherein the reading step is conducted before the receiving step.

4. The method of claim 2, wherein the reading step is conducted after the receiving step.

5. The method of claim 1, further comprising providing the digital data to a user through a user interface and allowing the user to modify the digital data through a data modification interface.

6. The method of claim 5, further comprising receiving modifications to the digital data to form modified digital data and storing the modified digital data with the tag identifier in the database system.

7. The method of claim 5, wherein the data modification interface comprises at least one of a keyboard or a touch screen interface.

8. The method of claim 5, wherein the user interface and the data modification interface are a common interface.

9. The method of claim 1, wherein the providing, receiving, using, associating, storing, and repeating steps are performed using a single processing system.

10. The method of claim 1, wherein the providing, receiving, using, associating, storing, and repeating steps are performed using a plurality of processing systems.

11. A system for identifying previously used liquefied petroleum gas (LPG) containers, comprising:
a microphone configured to receive voice signals representing information associated with a previously-used liquefied petroleum gas (LPG) container;
a speech recognition processor configured to convert the voice signals to digital data representing the information;
a database system; and
a processor configured to associate the digital data from the speech recognition processor with a tag identifier for a radio frequency identification (RFID) tag for the LPG container and to cause the digital data and the tag identifier to be stored in the database system;
wherein the system is configured to store digital data and tag identifiers for a plurality of previously-used LPG containers.

12. The system of claim 11, further comprising an RFID tag reader configured to read the RFID tag to obtain the tag identifier.

13. The system of claim 11, further comprising a user interface and wherein the processor is further configured to provide the digital data to a user through the user interface.

14. The system of claim 13, further comprising a data modification interface and wherein the processor is further configured to receive user modifications to the digital data through the data modification interface and to store modified digital data with the tag identifier in the database system.

15. The system of claim 14, wherein the user interface comprises at least one of a visual display system or a voice prompt system.

16. The system of claim 14, wherein the user interface and the data modification interface are provided through a common touch screen interface.

17. The system of claim 14, wherein the data modification interface comprises a keyboard.

18. The system of claim 11, wherein the microphone, speech recognition processor, database system, and processor are implemented within a single processing system.

19. The system of claim 11, wherein the microphone, speech recognition processor, database system, and processor are implemented within a plurality of processing systems.

20. The system of claim 11, wherein the previously-used LPG container comprises an LPG cylinder.
